(19) United States
(12) Patent Application Publication
(10) Pub. No.: US 2015/0036356 A1
(43) Pub. Date: Feb. 5, 2015

(54) OPTICAL LENS AND LIGHT SOURCE MODULE HAVING THE SAME

(71) Applicant: HON HAI PRECISION INDUSTRY CO., LTD., New Taipei (TW)

(72) Inventors: FENG-YUEN DAI, New Taipei (TW); CHAU-JIN HU, New Taipei (TW); YUNG-LUN HUANG, New Taipei (TW); LI-YING WANG HE, New Taipei (TW)

(73) Assignee: HON HAI PRECISION INDUSTRY CO., LTD., New Taipei (TW)

(21) Appl. No.: 13/967,354

(22) Filed: Aug. 15, 2013

(30) Foreign Application Priority Data
Aug. 2, 2013 (TW) 102127898

(51) Int. Cl. F21V 5/04

(52) U.S. Cl. CPC F21V 5/046
USPC 362/311.06; 362/326; 362/335; 362/311.01

(57) ABSTRACT

A light source module includes a light source and an optical lens facing the light source. The optical lens includes a light incident surface facing the light source, and a light emitting face opposite to the light incident face. The light emitted from the light source is entered into the optical lens from the light incident face, and exited from the light emitting face. A refractive index of the optical lens gradually decreases along a direction from the light incident face to the light emitting face of the optical lens.

### BACKGROUND

1. Technical Field

The disclosure generally relates to optical lenses, and particularly relates to an optical lens to increase an illuminating angle of a light source and a light source module having the optical lens.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

Generally, light intensity of a light emitting diode gradually decreases from a middle portion to lateral sides thereof. Such a feature makes the LED unsuitable for functioning as a light source which needs a uniform illumination, for example, a light source for a direct-type backlight module for a liquid crystal display (LCD). It is required to have an optical lens which can help the light from a light emitting diode to have a wider illuminating angle and a uniform intensity. Unfortunately, the conventional optical lens and a light source module having the conventional optical lens can not obtain a satisfactory effectiveness.

What is needed, therefore, is an optical lens and a light source module having the optical lens to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a light source module having an optical lens in accordance with a first embodiment of the present disclosure.

FIG. 2 is a cross section view of the light source module in FIG. 1, taken along a line II-II.

FIG. 3 is a schematic view of illuminating pattern of a conventional light source module.

FIG. 4 is a schematic view of illuminating pattern of the light source module in FIG. 1.

FIG. 5 is a cross section view of a light source module having an optical lens in accordance with a second embodiment of the present disclosure.

### DETAILED DESCRIPTION

Embodiments of an optical lens and a light source module will now be described in detail below and with reference to the drawings.

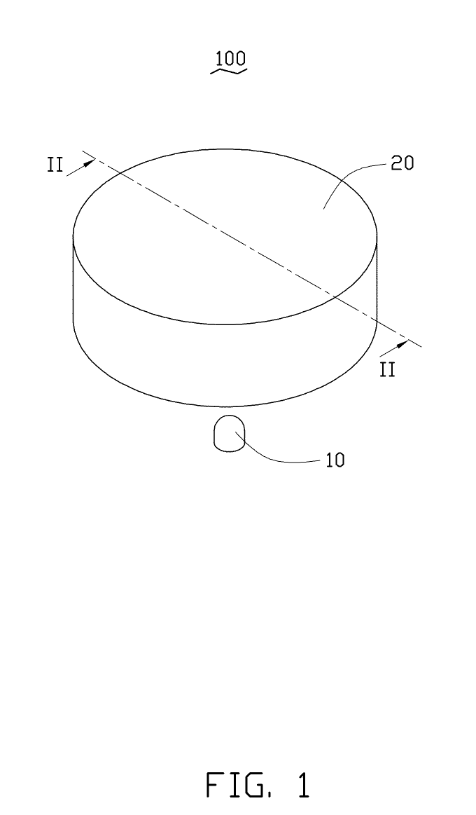

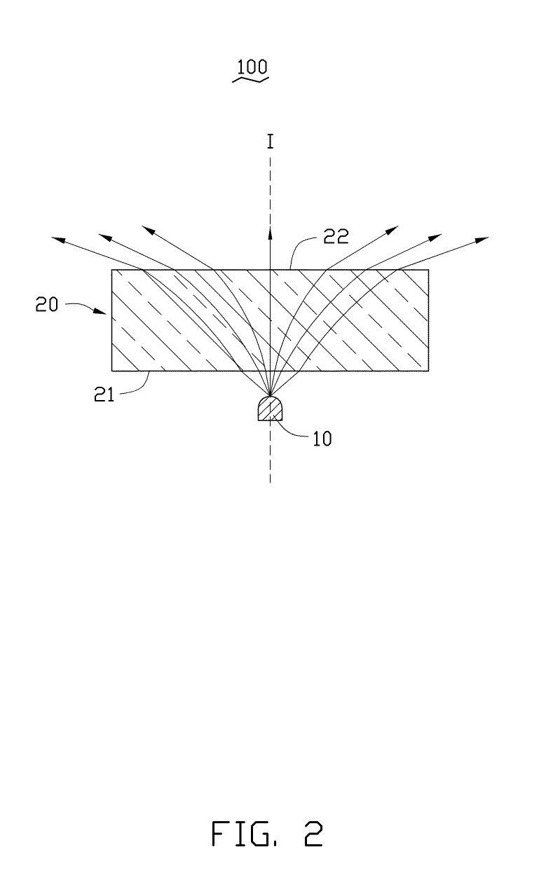

Referring to FIGS. 1-2, a light source module 100 in accordance with a first embodiment is illustrated. The light source module 100 includes a light source 10 and an optical lens 20 facing the light source 10. The optical lens 20 includes a light incident face 21 facing the light source 10 and a light emitting face 22 opposite to the light incident face 21. A refractive index of the optical lens 20 gradually decreases along a direction from the light incident face 21 to the light emitting face 22 of the optical lens 20.

The optical lens 20 is made of a material selected from a group consisting of polycarbonate (PC), polymethyl methacrylate (PMMA) and optical glass. The optical lens 20 has an optical axis I. In this embodiment, the optical lens 20 is axisymmetric with respect to the optical axis I. The light source 10 is placed aligned with the optical axis I. The light incident face 21 of the optical lens 20 is planar. The light emitting face 22 of the optical lens 20 is planar. The light incident face 21 is parallel to the light emitting face 22.

In this embodiment of the present discosure, the light source 10 is an LED chip, it may be made of semiconductor materials such as GaN, InGaN, AlInGaN or the like. Preferably, the LED chip emits visible light when being activated.

It could be understood, a plurality of fluorescence material, such as YAG, TAG, silicate, nitride, nitrogen oxides, phosphide, arsenide, telluride or sulfide, could be further provided to mix into the optical lens 20 or cover the optical lens 20.

Preferably, the refractive index of the optical lens 20 gradually decreases from 1.5 to 1.1, from the light incident face 21 to the light emitting face 22 of the optical lens 20.

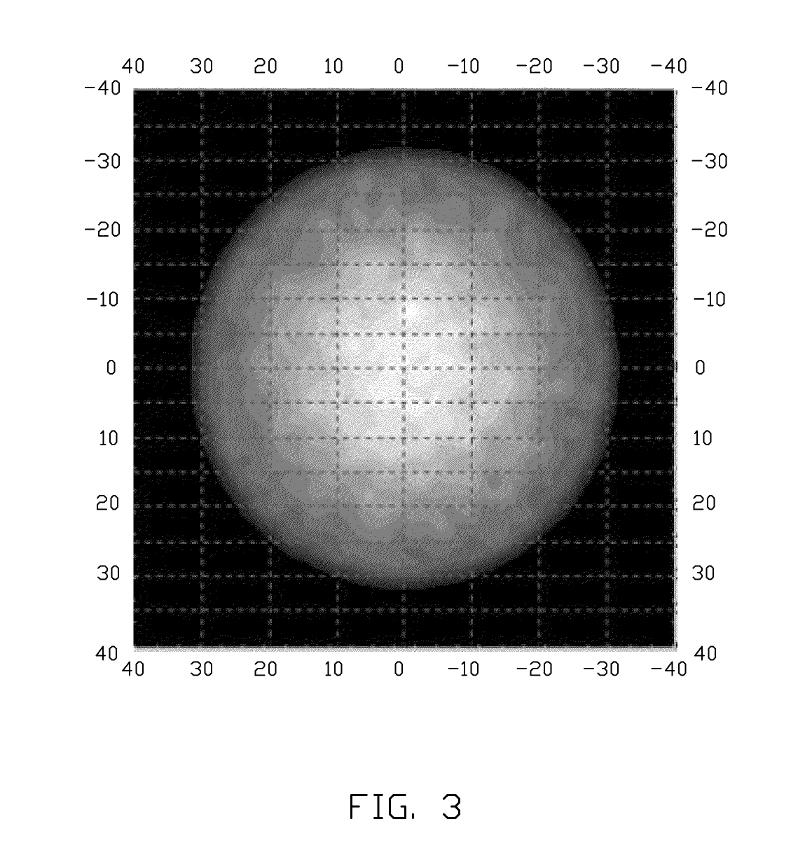

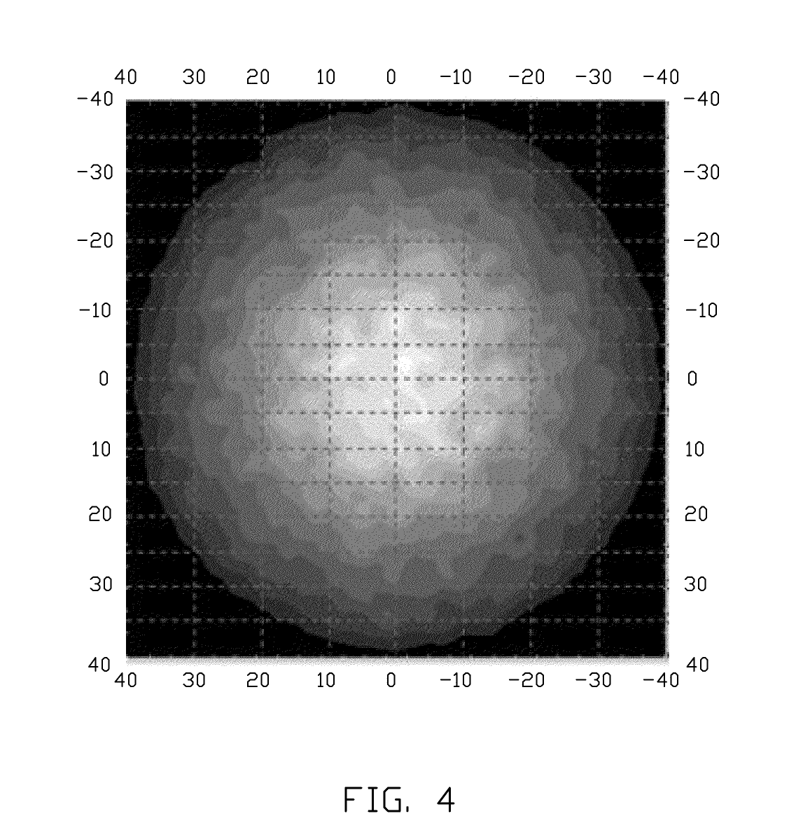

Referring to FIG. 2 again, in use, light emitted from the light source 10 is entered into the optical lens 20 from the light incident face 21, and exited from the light emitting face 22. When the light is transmitted in the optical lens 20, for the refractive index of the optical lens 20 gradually decreasing along the direction from the light incident face 21 to the light emitting face 22, the light is gradually diverged relative to the optical axis I of the optical lens 20, thus an illumination angle of the light source module 100 is widened and whereby the light source module 100 can illuminate more evenly. Referring to FIG. 3, it shows an illuminating pattern of a conventional light source module having a conventional optical lens, the conventional optical lens has a uniform refractive index of 1.5. In contrast, referring to FIG. 4, it shows an illuminating pattern of the light source module 100 having the optical lens 20 of the present disclosure.

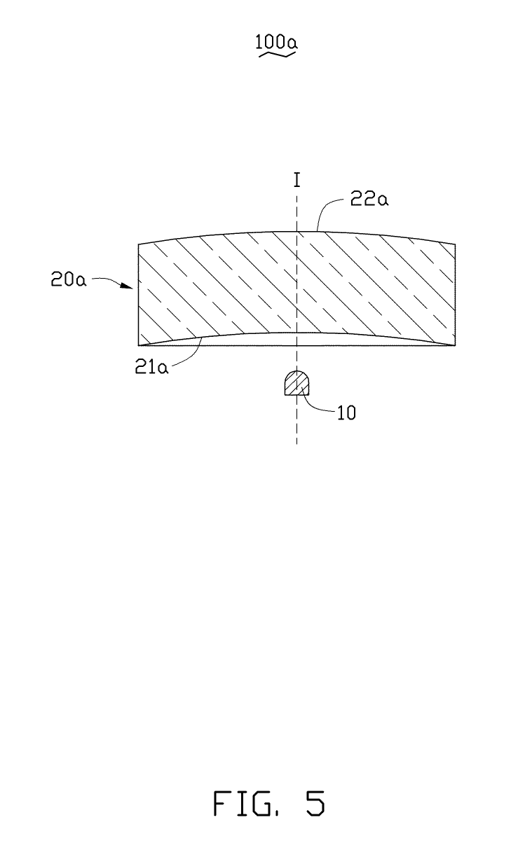

Preferably, the optical lens 20 and the light source module 100 are not limited to above embodiment. Referring to FIG. 5, a light source module 100a in accordance with a second embodiment includes the light source 10 and an optical lens 20a.

The optical lens 20a includes a light incident face 21a facing the light source 10 and a light emitting face 22a opposite to the light incident face 21a. A refractive index of the optical lens 20a gradually decreases along a direction from the light incident face 21a to the light emitting face 22a of the optical lens 20a.

The optical lens 20a is made of a material selected from a group consisting of polycarbonate (PC), polymethyl methacrylate (PMMA) and optical glass. The optical lens 20a has an optical axis I. In this embodiment, the optical lens 20a is axisymmetric with respect to the optical axis I. The light source 10 is placed aligned with the optical axis I. The light incident face 21 a of the optical lens 20a is curved. The light emitting face 22a of the optical lens 20a is curved. A middle portion of the light incident face 21a protrudes towards the light emitting face 22a. A middle portion of the light emitting face 22a protrudes away from the light incident face 21a.

In this embodiment of the present discosure, the light source 10 is an LED chip, it may be made of semiconductor materials such as GaN, InGaN, AlInGaN or the like. Preferably, the LED chip emits visible light when being activated.

It could be understood, a plurality of fluorescence material, such as YAG, TAG, silicate, nitride, nitrogen oxides, phosphide, arsenide, telluride or sulfide, could be further provided to mix into the optical lens 20a or cover the optical lens 20a.

Preferably, the refractive index of the optical lens 20a gradually decreases from 1.5 to 1.1, from the light incident face 21a to the light emitting face 22a of the optical lens 20a.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical lens for increasing illuminating angle of light emitted from a light source, comprising:
a light incident surface facing the light source; and
a light emitting face opposite to the light incident face;
wherein the light emitted from the light source is entered into the optical lens from the light incident face, and exited from the light emitting face; and
wherein a refractive index of the optical lens gradually decreases along a direction from the light incident face to the light emitting face of the optical lens.

2. The optical lens of claim 1, wherein the light incident face is planar.

3. The optical lens of claim 1, wherein the light emitting face is planar.

4. The optical lens of claim 1, wherein the light incident face is parallel to the light emitting face.

5. The optical lens of claim 1, wherein the light incident face is curved.

6. The optical lens of claim 5, wherein a middle portion of the light incident face protrudes towards the light emitting face.

7. The optical lens of claim 1, wherein the light emitting face is curved.

8. The optical lens of claim 7, wherein a middle portion of the light emitting face protrudes away from the light incident face.

9. The optical lens of claim 1, wherein the refractive index of the optical lens gradually decreases from 1.5 to 1.1, from the light incident face to the light emitting face.

10. The optical lens of claim 1, wherein the optical lens has an optical axis, and the optical lens is axisymmetric with respect to the optical axis.

11. A light source module comprising:
a light source; and
an optical lens facing the light source, and the optical lens comprising a light incident surface facing the light source, and a light emitting face opposite to the light incident face;
wherein the light emitted from the light source is entered into the optical lens from the light incident face, and exited from the light emitting face; and
wherein a refractive index of the optical lens gradually decreases along a direction from the light incident face to the light emitting face of the optical lens.

12. The light source module of claim 11, wherein the light incident face is planar.

13. The light source module of claim 11, wherein the light emitting face is planar.

14. The light source module of claim 11, wherein the light incident face is parallel to the light emitting face.

15. The light source module of claim 11, wherein the light incident face is curved.

16. The light source module of claim 15, wherein a middle portion of the light incident face protrudes towards the light emitting face.

17. The light source module of claim 11, wherein the light emitting face is curved.

18. The light source module of claim 17, wherein a middle portion of the light emitting face protrudes away from the light incident face.

19. The light source module of claim 11, wherein the refractive index of the optical lens gradually decreases from 1.5 to 1.1, from the light incident face to the light emitting face.

20. The light source module of claim 11, wherein the optical lens has an optical axis, the optical lens is axisymmetric with respect to the optical axis, and the light source is placed aligned with the optical axis.
